(19) United States
(12) Patent Application Publication
(10) Pub. No.: US 2003/0036391 A1
(43) Pub. Date: Feb. 20, 2003

(54) Relating to information delivery

(75) Inventor: Chris John Jordan, Cambridge (GB)

Correspondence Address: Wyatt, Tarrant & Combs, LLP, 1715 Aaron Brenner Drive, Suite 800, Memphis, TN, 37120, US

(73) Assignee: xemplix, ltd.

(21) Appl. No.: 10/172,204

(22) Filed: Jun. 14, 2002

(30) Foreign Application Priority Data
Aug. 25, 2000 (GB) 0020860.3
Jun. 21, 2001 (WO) 01/4831

(51) Int. Cl. H04B 5/00; H04Q 7/20; H04B 7/00; H04M 1/00; H04B 1/38

(52) U.S. Cl. 455/456; 455/517; 455/556

(57) ABSTRACT

A localized radio frequency information system utilizing a conventional wireless communication device such as a cellular telephone, adapted with a plug-in dedicated receiver and processor which receives the radio frequency from a low power transmitter which, for example, might be located at an object of art in a gallery, identifies one of several codes to a central control which identifies the location of the device and routes to the wireless communication device a voice or text message relevant to the particular location identified such as a descriptive message relating to the object of art at the identified location..

### CROSS REFERENCE TO RELATED APPLICATIONS:

This application claims priority of Great Britain patent application GB 9929718.6 file Dec. 16, 1999, and Great Britain application GB0020860.3 filed Aug. 25 2000, and PCT application PCT/GB00/04705 filed Dec. 11, 2000, and published as WO 01/44831, Jun. 21, 2001

### STATEMENT REGARDING FEDERALLY SPONSORED RESEARCH OR DEVELOPMENTS:

None

### BACKGROUND OF THE INVENTION

### FIELD OF INVENTION

This invention relates to a new information delivery system and a method of providing information delivery.

Cellular telephone systems currently provide the operators thereof with information about the geographic position of a user to within the accuracy of one “cell”, which is often several square kilometres in size, or one sector of a cell. Systems now in development will soon enhance the positioning resolution down to a few metres or better, either by integrating GPS (the satellite-based Global Positioning System) receivers into each telephone, or by taking advantage of the existing cellular radio signal through measurement of time of arrival, time difference of arrival (for example the CURSOR system designed by Cambridge Positioning Systems Ltd.) or angle of arrival (for example the TeleSentinel system from KSI Inc.)

All of these approaches have the following limitations:

The positioning information is only accurate to within a few metres at best

They suffer from loss of signal indoors (particularly in the case of GPS)

Portable devices are known which act as audio guides for museums, providing audio appropriate to the item that a visitor is viewing, or room in which he or she is standing (referred to hereafter simply as a “location”). These work in one of several ways:

Cassette player: The most common type is simply an audio-cassette player controlled manually by the visitor, talking him or her through the various locations. The user may pause or rewind the programme.

Radio station: A very low-power radio station broadcasts from each location (possibly with low-frequency magnetic fields or infra-red), and a receiver carried by the visitor receives only the information local to the item he or she is viewing (the user may possibly be able to tune to different radio channels for different languages). An example is the Easy Guide device produced by ColourArt.

Digital storage: The guide narrations are stored on the portable device itself, for example in solid-state memory or on disc, and coded audio transmitters in discrete locations which trigger the device to play back the appropriate narration—an example is the Easy Guide device with optional flash card.

The “cassette player” approach has the following limitations:

It is entirely manual—the device tells the user where to walk next and the user must follow the directions to hear audio that is relevant.

Audio playback is not context-sensitive.

No opportunity for feedback from the user to the operator.

The “radio station” approach has the following limitations;

It requires a relatively expensive custom device to receive the broadcasts.

It may not be under the full interactive control of the user, and cannot be paused, rewound etc.

It cannot easily be personalised to each user's changing preferences.

The shape and size of the region covered by each location is not easily controllable.

No opportunity for feedback from the user to the operator.

The “Digital Storage” approach has the following limitations:

It requires a relatively expensive custom device to play back the narrations.

The information may go out of date, whereupon every device must be updated. This precludes delivery of real-time information.

To offer the user a free choice of alternative narrations (such as versions in different languages), much greater storage capacity is required and the capacity used by the Alternatives not chosen is wasted.

No opportunity for feedback from the user to the operator.

It is known from DE 197 47 745 to provide an information delivery system for use in museums and the like, the system comprising a communication unit having an earpiece and a microphone. A position detection system locates each communication unit and allows communication therewith by way of a unit specific frequency channel, the communication relating to an exhibit in the vicinity of the unit. This system requires a dedicated custom-built communication unit, and therefore suffers from the problems outlined above.

### SUMMARY OF THE INVENTION

According to a first aspect of the present invention there is provided a local information delivery system comprising a wireless communications device and a central control system, characterised in that the wireless communications device is a standard wireless communications device and in that the system includes either a low-power transmitter placed at each of a plurality of locations and a receiver and processor attached to the wireless communications device, or a low-power transmitter attached to the standard wireless communications device and a receiver and processor placed at each of a plurality of locations, the processor in either case being adapted to distinguish a unique code transmitted by the transmitter and thereby to send a message to the central control system identifying and locating the wireless communications device and thereby to deliver location-specific information to the wireless communications device.

Such a system is advantageous because it combines a familiar, standard, low-cost wireless communications device (which a visitor may already own) together with a low-cost device which controls the flow of information to the wireless communications device, providing a low-cost, location-sensitive solution to information delivery, with potentially very high spatial resolution.

According to a second aspect of the present invention, there is provided a method of delivering location specific information to a wireless communications device from a central control system, characterised in that:

i) a low-power transmitter is attached to the wireless communications device;

ii) a plurality of receivers each including a processor is distributed over a plurality of locations;

iii) the low-power transmitter transmits a code unique to that transmitter to at least the nearest of said receivers;

iv) the processor of said receiver sends a signal to the central control system including both the code and information regarding the location of the wireless communications device with reference to the locations of said plurality of receivers;

v) the central control system identifies and locates the wireless communications device by way of the code and the location information provided by the processor and delivers location-specific information to the wireless communications device.

According to a third aspect of the present invention, there is provided a method of delivering location-specific information to a wireless communications device from a central control system, characterised in that:

i) a plurality of low power transmitters is distributed over a plurality of locations;

ii) a receiver including a processor is attached to the wireless communications device;

iii) each of the plurality of low-power transmitters transmits a code unique to that transmitter, the code being receivable by said receiver;

iv) the processor, upon reception of said code from said receiver, sends a signal to the central control system including both the code and information regarding the location of the wireless communications device with reference to the locations of said plurality of transmitters; and

v) the central control system identifies and locates the wireless communications device byway of the code and the location information provided by the processor and delivery location-specific information to the wireless communications device.

Such a method is advantageous because it provides much smaller location resolution than is possible with existing or envisaged cellular networks, and provide a low-cost means of delivering location-dependent information by reusing existing mass-market cellular telephones and the like.

The wireless communications device may be of any common type, being for the purposes of this invention any system which provides its user with information received from a network. It may far example provide information via audio (possibly via a headset), or text (possibly via Short Message Service (SMS), Wireless Application Protocol (WAP), HTML (or other network protocol), or even video. It may additionally allow some form of user-input back to the central control system (including, but not limited to, DTMF (Dual-Tone Multi-Frequency) keypad tones).

The low-power transmitter (“transmitter”) may be of any type, accepting digital data, and transmitting it either as electromagnetic waves in the visible, infra-red or radio-frequency parts of the spectrum, or emitting audible tones, possibly ultrasonic, and using any modulation scheme including but not limited to amplitude-keying, amplitude modulation, frequency-keying, frequency-modulation, frequency-hopping or spread-spectrum. Alternatively, the transmitter may operate by modulating an existing form of radiation, for example a light bulb.

The receiver is matched to the characteristics of transmissions from the transmitter, translating the received data back into digital form.

Embodiments of the present invention include a microprocessor or microcontroller operable to process data received by the receiver and to cause data regarding a location of the wireless communications device to be sent to the central control system..

The processor is attached to the receiver and may be any type of microcontroller or microprocessor, running a software program which interprets the data from the receiver and sends a message to the central control system informing it of the location of the wireless communications device.

As explained above, either the transmitter is attached to the wireless communications device and a receiver placed at each location, or a receiver is attached to the wireless communications device and a transmitter placed at each location. In the former case, the location-based receiver sends information about nearby transmitters (uses) to the central-control station, possibly by wires, radio transmissions or other means. In the latter case, the user-based receiver sends information about nearby transmitters (locations) to the central control station, possibly by sending DTMF tones or other signalling either carried over the wireless communications device's voice, data or network control bands.

The central control system is interfaced to each user's wireless communications device via the device's normal, network, which might be a dialled-up cellular connection, local wireless network, or some other networking protocol such as Wireless Application Protocol (WAP), point-to-point infra-red data transfer possibly using the Infra-red Data Association protocol or Bluetooth (a short-range radio-frequency protocol from Ericsson, et al which enables two or more wireless devices to be networked together in a “scatternet”), possibly also travelling via the Public Switched Telephone Network (PSTN). As the central control system receives messages from the processing means attached to the receiver, it modifies the data that it delivers to the wireless communications device. For example, the central control system could be a voicemail system (possibly controlled by DTMF tones), or a server running a menu-driven WAP application or a transaction and billing system.

The wireless communications device may be a cellular telephone or videophone (for example GSM, PCS, UMTS or TETRA), or a cordless telephone (for example DECT), or a personal digital assistant (PDA) with a wireless interface (e.g. palm Pilot VII®), or a wireless headset (e.g. using the Bluetooth wireless protocol) which may include means for delivering audio information by way of earphones and,optionally, visual information by way of a head-up display device.

Each receiver may optionally have a means to compare the signal-strength or time-of-arrival of transmissions from several transmitters, allowing the system to determine the location of the user to a greater resolution than simply to the nearest transmitter or receiver.

Optionally the system may be partly controlled by the location system described, and partly by the user, allowing the user to operate either in “automatic” mode with the system providing appropriate information as he or she moves about, or to take “manual” control at any point, for example to hear information paused or repeated, or to hear more or different information.

The transmitter or receiver attached to the wireless communications device may:

be permanently or temporarily attached

optionally have as antenna or other interface which is directional, providing information about the direction in which the wireless communications device is pointing or equivalently the orientation in which it is being held

optionally include a component for detecting the orientation of the device in one or more dimensions relative to the pull of the Earth's gravity or the direction of the Earth's magnetic field

be powered by the wireless communications device's battery, or powered by its own internal power source, which may be a primary or secondary cell, or even an inductive pickup

The receiver may optionally be adapted to enter a state of very low power consumption until a new transmission is detected.

Each location may be fixed or may be mobile, with a system potentially comprising some fixed and some mobile locations.

Both a transmitter and receiver may optionally be attached to the wireless communications device, allowing two-way information transfer independent of the wireless communications device's network. This effectively makes every “user” also a “location”, allowing users to obtain information about each other (social systems).

Optionally the system may detect attempts to take the attached device away from the zone of operation. (for example, the museum) and remind the user to return the device.

Optionally the central control system may be provided with a means for users to leave a message about each location, in either voice, text or other formats, which will then be available to other users.

Optionally the central control system may provide information about the location of users, to a central display, or to other users or groups of users, or to an external network such as the Internet, providing a useful means of finding lost children, parents etc., and of tracking customer behaviour.

Optionally, the transmitting means of this invention may be any transmitting means already incorporated into the wireless communications device, such as those described hereinabove, including Bluetooth and IrDA.

Optionally, the processor of this invention may be a processor already incorporated into the wireless communications device.

Optionally, the receiver of this invention may be any receiver already incorporated into the wireless communications device, such as those described hereinabove, including Bluetooth and IrDA.

Optionally, the wireless communications device may be used in conjunction with a “hands-free” earpiece or headset. In such a case, any directionality-sensing apparatus may be incorporated into the “hands-free” equipment rather than the wireless communications device itself, thus better sensing the direction in which the user's attention is focused.

### DESCRIPTION OF THE DRAWINGS

For a better understanding of the present invention and to show it may be carried into effect, reference shall, now be made, by way of example, to the accompanying drawings, in which:

FIG. 1 shows a first embodiment of the present invention in which a receiver and processor means is attached to mobile telephone; and

FIG. 2 shows a second embodiment of the present invention in which a transmitter is attached to a mobile telephone.

### DETAILED DESCRIPTION OF THE DRAWINGS

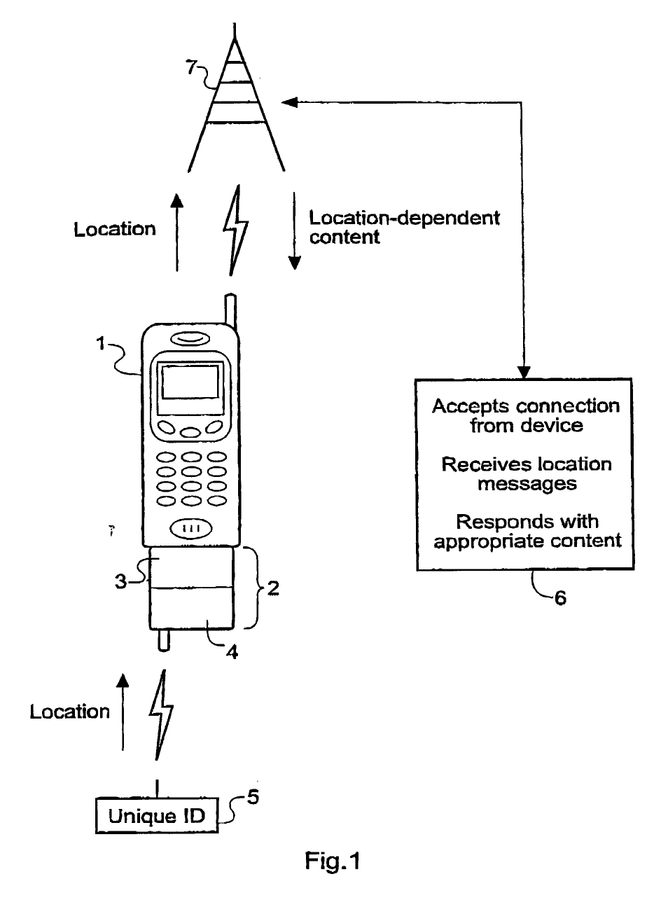

Referring firstly to FIG. 1, there is shown mobile telephone 1 to which is attached a module 2 comprising a processing unit 3 and a receiving unit 4. The module 2 is attached to the mobile telephone 1 by way of a standard I/O port (not shown.) which is commonly found on all standard mobile telephones. A low-power transmitting unit 5 is positioned at a specific location, which for the purposes of the present example may be taken to be a location where a given work of art (not shown) is located in an art gallery. The transmitting unit 5 is adapted to transmit a code signal unique to itself within a predetermined range therefrom. Each work of art in the art gallery is located close to a discrete transmitting unit 5 which transmits a unique coded signal. A central control system 6, in the form of an electronic computer, is provided in the art gallery and connected to or otherwise in communication with an antenna 7 adapted to transmit audio information representative of the various works of art displayed in the art gallery to standard mobile telephones 1.

When a person enters the art gallery, he or she is provided with the module 2 which is then attached to his or her mobile telephone 1 by way of the standard I/O port. As the person moves amend the art gallery to view the works of art, the receiving unit 4 receives code signals from the transmitting units 5. The transmitting units 5 transmit their code signals only within a given range, so that the receiving unit 3 only receives the code signal when the person with the mobile telephone 1 is in close proximity to a given work of art. When the receiving unit 3 receives a coded signal from a given transmitting unit 5, it passes the signal on to the processing unit 4, which then activates the mobile telephone 1 to transmit the coded signal by way of its own standard communication protocol to the antenna 7 and hence to the central control system 6. The signal received by the central control system 6 includes the coded signal, which identifies the transmitting unit 5 and thereby its associated work of art, and also information regarding the identity of the mobile telephone 1. The central control system 6 is then able to determine the identity of the mobile telephone 1 and also that it is in close proximity to a given transmitting unit 5 and associated work of art. The central control system 6 then causes the antenna 7 to transmit to the mobile telephone 1, by way of the standard communication protocol of the mobile telephone 1, a narrative regarding the work of art. As the person visiting the art gallery moves from one work of art to another, the receiving unit 3 receives coded signals from different transmitting units 5 each associated with a different work of art, and the central control system 6 is therefore able to determine the location of the person in relation to the works of art and to transmit a narrative appropriate to each individual work of art to the mobile telephone 1 as the person moves around the art gallery. When the person leaves the art gallery, he or she will detach the module 2 front his or her mobile telephone 1 and return the module to the art gallery for use by another visitor.

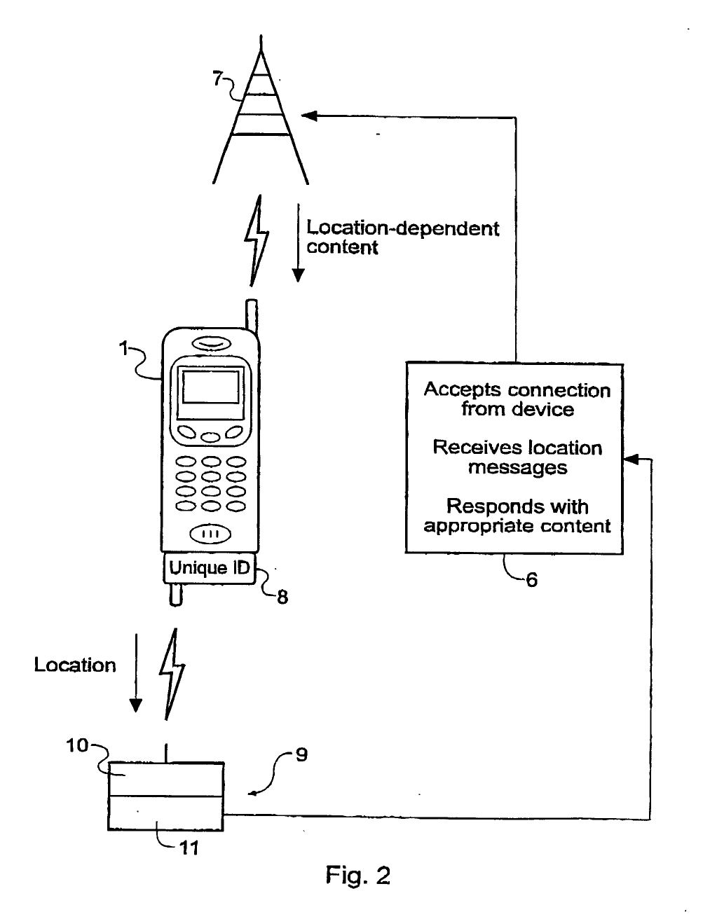

Alternatively, as shown in FIG. 2, there is shown a standard mobile telephone 1 to which is attached, by way of the I/O port of the mobile telephone 1, a module 8 comprising a low-power transmitting unit. The module 8 functions in a similar manner to the transmitting unit 5 of the embodiment of FIG. 1, and is adapted to transmit a code signal unique to itself within a predetermined range therefrom. Each work of art in the art gallery is provided with a module 9 which includes a receiving unit 10 and a processing unit 11 and which is in communication with the central control system 6 by way of any appropriate means. As before, the cental control system 6 is in communication with an antenna 7 adapted to transmit audio information representative of the various works of art displayed in the art gallery to the standard mobile telephone 1.

When a person enters the art gallery, he or she is provided with the module 8 which is then attached to his or her mobile telephone 1 by way of the standard I/O port As the person moves around the art gallery to view the works of art, the receiving units 10 of the modules 9 associated with the works of art receive a code signal from the module 8 attached to the mobile telephone 1. The module 8 transmits its code signal only within a given range, so that the receiving units 10 only receive the code signal when the person with the mobile telephone 1 is in close proximity to a given work of art. When a receiving unit 10 receives a coded signal from a nearby module 8, it passes the signal on to its associated processing unit 11, which then communicates the coded signal and information relating to its identity and location to the central control system. 6. The signal received by the central control system 6 includes the coded signal, which serves to identify the module 8, and also information identifying the location of the module 9 and hence its associated work of art. The central control system 6 is thus able to determine the identity of the mobile telephone 1 and also that it is in close proximity to a given module 9 and associated work of art. The central control system 6 then causes the antenna 7 to transmit to the mobile telephone 1, by way of the standard communication protocol of the mobile telephone 1, narrative regarding the work of art. As the person visiting the art gallery moves from one work of art to another, the receiving units 10 in turn receive the coded signal from the module 8, and the central control system 6 is therefore able to determine the location of the person in relation to the works of art and to transmit a narrative appropriate to each individual work of art to the mobile telephone 1 as the person moves around the art gallery. When the person leaves the art gallery, he or she will detach the module 8 from his or her mobile telephone 1 and return the module 8 to the art gallery for use by another visitor.

The disclosed embodiments are to be considered in all respects as illustrative and not restrictive. Those skilled in the art will recognize that variations may be made in the implementation of directing and processing of signals, however, the scope of the invention is to be defined by the appended claims rather than the foregoing description and other embodiments which come into the meaning and range of equivalency of the claims are therefor intended to be included in the scope hereof.

1. A local information delivery system comprising a wireless communications device (1) and a central control system (6), wherein the wireless communications device (1) is a standard wireless communications device (1) and wherein the system includes either a low-power transmitter (5) placed at each of a plurality of locations and a receiver (4) and processor (3) attached to the wireless communications device (1), or a low-power transmitter (8) attached to the standard wireless communications device (1) and a receiver (10) and processor (1) placed at each of a plurality of locations, the processor (3, 11) in either case being adapted to distinguish a unique code transmitted by the transmitter (5, 8) and thereby to send a message to the central control system (6) identifying and locating the wireless communications device (1) and thereby to deliver location-specific information to the wireless communications device (10).

2. A system as claimed in claim 1, wherein the wireless communications device (1) is a mobile telephone or mobile videophone.

3. A system as claimed in claim 1, wherein the wireless communications device (1) is a pocket computer device such as a personal digital assistant provided with a wireless communications interface.

4. A system as claimed in claim 1, wherein the wireless communications device (1) is a wireless headset.

5. A system as claimed in claim 1, wherein the location-specific information is adapted to be output from the wireless communications device (1) as an audio signal.

6. A system as claimed in claim 1, wherein the location-specific information is adapted to be output from the wireless communications device (1) as a visual signal, for example in the form of text, graphics or video.

7. A system as claimed in claim 1, where the receiver (4, 10) is adapted to compare signal 6 strength or time-of-arrival of transmissions from several transmitters (5, 8) so as to enable the system to determine a location of the wireless communications device (1).

8. A system as claimed in claim 1, where the wireless communications device (1) is operable to issue control signals to the central control system (6).

9. A system as claimed in claim 1, wherein the transmitter (8) or receiver (4) attached to the wireless communications device (1) is releasably attached thereto.

10. A system as claimed in any preceding claim, wherein the transmitter (8) or receiver (4) attached to the wireless communications device (1) includes an antenna or other interface that is directional, thus enabling information regarding a spatial orientation of the wireless communications device (1) to be communicated to the central control system (6).

11. A system as claimed in claim 1, wherein the transmitter (8) or receiver (4) attached to the wireless communications device (1) is adapted to detect a spatial orientation of the wireless communications device (1) with respect to a terrestrial magnetic or gravitational field, thus enabling information regarding the spatial orientation of the wireless communications device (1) to be communicated to the central control system (6).

12. A system as claimed in claim 1, wherein both a transmitter (8) and a receiver is attached to the wireless-communications device (1), thereby enabling two-way information transfer independently of any communications protocol associated with the wireless communications device (1) itself.

13. A system as claimed in claim 1, wherein the transmitter (5, 8) and the receiver (4, 10) communicate information by way of a communications protocol independent of any communications protocol associated with the wireless communications device (1) itself.

14. A system as claimed in claim 1, wherein the transmitter (5, 8) and the receiver (4, 10) communicate information by way of a communications protocol already associated with the wireless communications device (1) itself.

15. A method of delivering location-specific information to a wireless communications device (1) from a central control system (6), wherein:
i) a low-power transmitter (8) is attached to the wireless communications device (1);
ii) a plurality of receivers (10) each including a processor (11) is distributed over a plurality of locations;
iii) the low-power transmitter (8) transmits a code unique to that transmitter (8) to at least the nearest of said receivers (10);
iv) the processor (11) of said receiver (10) sends a signal to the central control system (6) including both the code and information regarding the location of the wireless communications device (1) with reference to the locations of said plurality or receivers (10);
v) the central control system (6) identifies and locates the wireless communications device (1) by way of the code and the location information provided by the processor (11) and delivers location-specific information to the wireless communications device (1).

16. A method of delivering location-specific information to a wireless communications device (1) from a central control system (6), wherein:
i) a plurality of low-power transmitters (5) is distributed over a plurality of locations;
ii) a receiver (4) including a processor (3) is attached to the wireless communications device (1);
iii) each of the plurality of low-power transmitters (5) transmits a code unique to that transmitter (5), the code being receivable by said receiver (4);
iv) the processor (3), upon reception of said code from said receiver (4), sends a signal to the central control system (6) including both the code and information regarding the location of the wireless communications device (1) with reference to the locations of said plurality of transmitters (5); and
v) the central control system (6) identifies and locates the wireless communications device (1) by way of the code and the location information provided by the processor (3) and delivers location-specific information to the wireless communications device (1).

17. A method according to claim 15, wherein the location-specific information is output from the wireless communications device (1) as an audio signal.

18. A method according to claim 15, wherein the location-specific information is output from the wireless communications device (1) as a visual signal, for example in the form of text, graphics or video.

19. A method according to claim 15, wherein the transmitters (5, 8) and the receivers (4, 10) communicate information by way of a communications protocol independent of any communications protocol associated with the wireless communications device (1) itself.

20. A method according to claim 15, wherein the transmitters (5, 8) and the receivers (4, 10) communicate information by way of a communications protocol already associated with the wireless communications device (1) itself.

21. A method according to claim 16, wherein the location-specific information is output from the wireless communications device (1) as an audio signal.

22. A method according to claim 16, wherein the location-specific information is output from the wireless communications device (1) as a visual signal, for example in the form of text, graphics or video.

23. A method according to claim 16, wherein the transmitters (5, 8) and the receivers (4, 10) communicate information by way of a communications protocol independent of any communications protocol associated with the wireless communications device (1) itself.

24. A method according to claim 16, wherein the transmitters (5, 8) and the receivers (4, 10) communicate information by way of a communications protocol already associated with the wireless communications device (1) itself.
